(19) United States
(12) Patent Application Publication
(10) Pub. No.: US 2025/0338137 A1
(43) Pub. Date: Oct. 30, 2025

(54) CROSS-TECHNOLOGY SPECTRUM SHARING

(71) Applicant: QUALCOMM Incorporated, San Diego, CA (US)

(72) Inventors: Aleksandar DAMNJANOVIC, Del Mar, CA (US); George CHERIAN, San Diego, CA (US); Soo Bum LEE, San Diego, CA (US); Abhishek Pramod PATIL, San Diego, CA (US); Marco PAPALEO, Bologna (IT); Tevfik YUCEK, San Jose, CA (US)

(21) Appl. No.: 18/651,277

(22) Filed: Apr. 30, 2024

(51) Int. Cl. H04W 16/14; H04W 84/04; H04W 84/12

(52) U.S. Cl. CPC H04W 16/14; H04W 84/042; H04W 84/12

(57) ABSTRACT

Various aspects of the present disclosure generally relate to wireless communication. In some aspects, a wireless station may receive spectrum sharing information from a network entity or a user equipment (UE). The wireless station may perform an action associated with sharing a spectrum with cellular communications. Numerous other aspects are described.

### FIELD OF THE DISCLOSURE

Aspects of the present disclosure generally relate to wireless communication and specifically relate to techniques, apparatuses, and methods for sharing a spectrum across technologies.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

A wireless local area network (WLAN) may be formed by one or more access points (APs) that provide a shared wireless communication medium for use by a number of client devices, also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

To improve data throughput, the AP may communicate with one or more STAs over multiple concurrent communication links. Each of the communication links may be of various bandwidths, for example, by bonding a number of 20 MHz-wide channels together to form 40 MHz-wide channels, 80 MHz-wide channels, or 160 MHZ-wide channels. The AP may establish BSSs on any of the different communication links, and therefore it is desirable to improve communication between the AP and the one or more STAs over each of the communication links.

### SUMMARY

In some scenarios, entities of different technologies, such as cellular (e.g., 5G/6G network entity or user equipment (UE)) entities and (non-cellular) wireless local area network (WLAN) protocol entities (e.g., Wi-Fi entities, wireless station (STA), wireless access point (AP)), may share a wireless spectrum. However, the technologies are scheduled separately and thus cellular communications and WLAN protocol communications may interfere with each other. Interference degrades communications, and degraded communications decreases throughput, wastes signaling resources, and increases latency.

According to various aspects described herein, the cellular entities may utilize a WLAN or Wi-Fi waveform for cross-technology signaling. For example, a UE may transmit cross-technology signaling, such as spectrum sharing information, to a wireless station (STA), (e.g., Wi-Fi mobile STA), using a Wi-Fi waveform or protocol. The spectrum sharing information may indicate how the wireless STA is to operate in the shared spectrum. When the wireless STA receives the spectrum sharing information, the wireless STA may perform an action associated with sharing the spectrum with cellular communications. The spectrum sharing information may indicate the action or include parameters for the action. In some aspects, the action may include limiting non-cellular communications to a portion of the spectrum, reducing power for WLAN protocol communications in the spectrum, or time domain sharing with cellular communications in the spectrum. By receiving cross-technology signaling from a cellular entity and performing an action based at least in part on the spectrum sharing information, the wireless STA may improve the use of the spectrum shared with cellular entities. As a result, throughput increases from both cellular entities and WLAN protocol entities that use the shared spectrum, signaling resources are conserved, and latency is reduced.

When WLAN protocol interference is detected, the network entity or the UE may transmit spectrum sharing information to the wireless STA or the wireless AP. However, there may be an issue with the wireless STA or the wireless AP detecting the spectrum sharing information. If this information is missed, cellular and WLAN protocol communications will continue to interfere with each other, which degrades communication and results in decreased throughput and increased latency.

In some aspects, the network entity may configure the UE to transmit a cross-technology message, such as the spectrum sharing information, in one or more time instances. The one or more time instances may be in one or more configured gaps. The UE may request the gaps and transmit spectrum sharing information in the gaps. The wireless AP (or the wireless STA) may be configured to monitor for cross-technology signaling in the gaps. However, the use of the gaps, parameters, and/or interference mitigation techniques may depend on the synchronization capabilities of the wireless AP. In some aspects, the wireless AP may acquire synchronization autonomously through a Global Navigation Satellite System (GNSS) receiver or through cross-technology signaling from the network entity or UE. Cross-technology signaling in the gaps allows the wireless AP (GNSS synchronized) to sense the channel at specific time instances and utilize the channel in between the two instances without the risk of missing detection of the cross-technology signaling. Synchronization allows the wireless AP to be more aggressive with sharing resources with the network entity and/or the UE, because there is a mechanism to more reliably detect cross-technology signaling. Synchronization also allows the use of smaller gaps. As a result of the UE requesting and using (smaller) gaps and the wireless AP obtaining synchronization, the throughput for the network entity, the UE, the wireless STA, and the wireless AP increase and the latency is reduced.

Some aspects described herein relate to a method of wireless communication performed by a wireless STA. The method may include receiving spectrum sharing information from a network entity or a UE. The method may include performing an action associated with sharing a spectrum with cellular communications.

Some aspects described herein relate to a method of wireless communication performed by a network entity or UE. The method may include receiving sharing data that is associated with a service level agreement between a cellular channel measurement function (CMF) and a non-cellular authorization server for sharing a spectrum between cellular communications and WLAN protocol communications. The method may include transmitting, to a wireless STA, spectrum sharing information that is based at least in part on the sharing data.

Some aspects described herein relate to a method of wireless communication performed by a wireless AP. The method may include receiving, from an authorization server, a spectrum sharing policy that is associated with a service level agreement between the authorization server and a CMF. The method may include transmitting, to a wireless STA, parameters for an action to be performed by the wireless STA in association with sharing a spectrum with cellular communications.

Some aspects described herein relate to an apparatus for wireless communication at a wireless STA The apparatus may include one or more memories and one or more processors coupled to the one or more memories. The one or more processors may be individually or collectively configured to receive spectrum sharing information from a network entity or a UE. The one or more processors may be individually or collectively configured to perform an action associated with sharing a spectrum with cellular communications.

Some aspects described herein relate to an apparatus for wireless communication at a network entity or UE. The apparatus may include one or more memories and one or more processors coupled to the one or more memories. The one or more processors may be individually or collectively configured to receive sharing data that is associated with a service level agreement between a CMF and an authorization server for sharing a spectrum between cellular communications and WLAN protocol communications. The one or more processors may be individually or collectively configured to transmit, to a wireless STA, spectrum sharing information that is based at least in part on the sharing data.

Some aspects described herein relate to an apparatus for wireless communication at a wireless AP. The apparatus may include one or more memories and one or more processors coupled to the one or more memories. The one or more processors may be individually or collectively configured to receive, from an authorization server, a spectrum sharing policy that is associated with a service level agreement between the authorization server and a CMF. The one or more processors may be individually or collectively configured to transmit, to a wireless STA, parameters for an action to be performed by the wireless STA in association with sharing a spectrum with cellular communications.

Some aspects described herein relate to a non-transitory computer-readable medium that stores a set of instructions for wireless communication by a wireless STA. The set of instructions, when executed by one or more processors of the wireless STA, may cause the wireless STA to receive spectrum sharing information from a cellular entity. The set of instructions, when executed by one or more processors of the wireless STA, may cause the wireless STA to perform an action associated with sharing a spectrum with cellular communications.

Some aspects described herein relate to a non-transitory computer-readable medium that stores a set of instructions for wireless communication by a network entity or UE. The set of instructions, when executed by one or more processors of the network entity or UE, may cause the cellular entity to receive sharing data that is associated with a service level agreement between a CMF and an authorization server for sharing a spectrum between cellular communications and WLAN protocol communications. The set of instructions, when executed by one or more processors of the network entity or UE, may cause the network entity or UE to transmit, to a wireless STA, spectrum sharing information that is based at least in part on the sharing data.

Some aspects described herein relate to a non-transitory computer-readable medium that stores a set of instructions for wireless communication by a one or more instructions that, when executed by one or more processors of a wireless AP. The set of instructions, when executed by one or more processors of the one or more instructions that, when executed by one or more processors of a wireless AP, may cause the one or more instructions that, when executed by one or more processors of a wireless AP to receive, from an authorization server, a spectrum sharing policy that is associated with a service level agreement between the authorization server and a CMF. The set of instructions, when executed by one or more processors of the one or more instructions that, when executed by one or more processors of a wireless AP, may cause the one or more instructions that, when executed by one or more processors of wireless AP to transmit, to a wireless STA, parameters for an action to be performed by the wireless STA in association with sharing a spectrum with cellular communications.

Some aspects described herein relate to an apparatus for wireless communication. The apparatus may include means for receiving spectrum sharing information from a network entity or a UE. The apparatus may include means for performing an action associated with sharing a spectrum with cellular communications.

Some aspects described herein relate to an apparatus for wireless communication. The apparatus may include means for receiving sharing data that is associated with a service level agreement between a CMF and an authorization server for sharing a spectrum between cellular communications and WLAN protocol communications. The apparatus may include means for transmitting, to a wireless STA, spectrum sharing information that is based at least in part on the sharing data.

Some aspects described herein relate to an apparatus for wireless communication. The apparatus may include means for receiving, from an authorization server, a spectrum sharing policy that is associated with a service level agreement between the authorization server and a CMF. The apparatus may include means for transmitting, to a wireless STA, parameters for an action to be performed by the wireless STA in association with sharing a spectrum with cellular communications.

Aspects of the present disclosure may generally be implemented by or as a method, apparatus, system, computer program product, non-transitory computer-readable medium, user equipment, base station, network node, network entity, wireless communication device, wireless STA, wireless AP, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 shows a pictorial diagram of another example wireless communication network, in accordance with the present disclosure.

FIG. 5 is a diagram illustrating an example of a wireless communication device, in accordance with the present disclosure.

FIG. 6 is a diagram illustrating an example of a protocol stack, in accordance with the present disclosure.

FIG. 7 is a diagram illustrating an example of cross-technology sharing, in accordance with the present disclosure.

FIG. 8 is a diagram illustrating an example of cross-technology signaling, in accordance with the present disclosure.

FIG. 9 is a diagram illustrating an example of cross-technology signaling, in accordance with the present disclosure.

FIG. 10 is a diagram illustrating an example of cross-technology signaling, in accordance with the present disclosure.

FIG. 11 is a diagram illustrating an example of cross-technology signaling, in accordance with the present disclosure.

FIG. 12 is a diagram illustrating an example of transmitting spectrum sharing information in configured gaps, in accordance with the present disclosure.

FIG. 13 is a diagram illustrating an example process performed, for example, at a wireless station or an apparatus of a wireless station, in accordance with the present disclosure.

FIG. 14 is a diagram illustrating an example process performed, for example, at a network entity or UE or an apparatus of a network entity or UE, in accordance with the present disclosure.

FIG. 15 is a diagram illustrating an example process performed, for example, at a wireless access point or an apparatus of a wireless access point, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

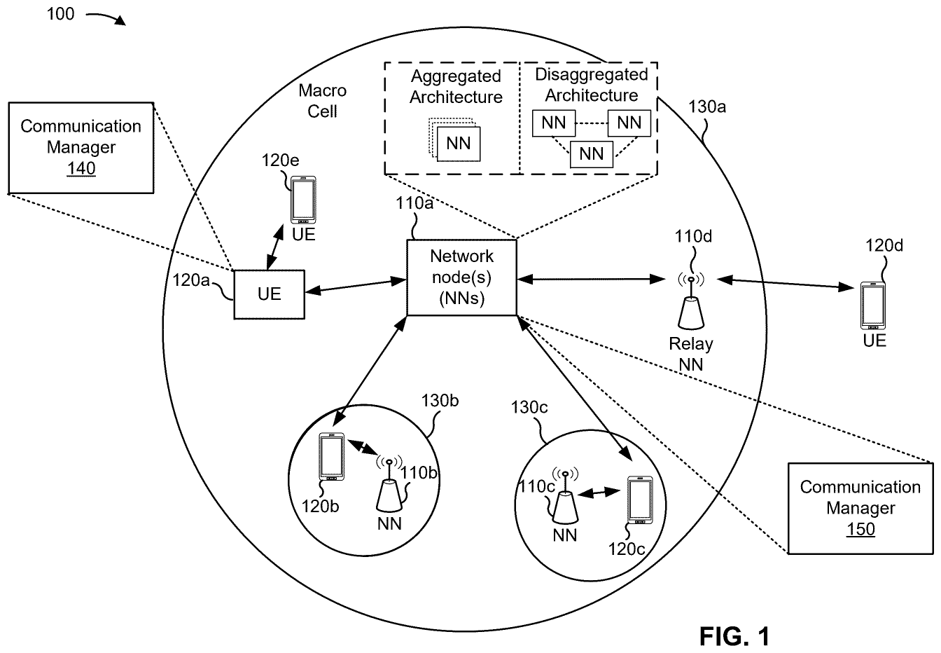

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NCJT).

As indicated above, FIG. 1 is provided as an example. Other examples may differ from what is described with regard to FIG. 1.

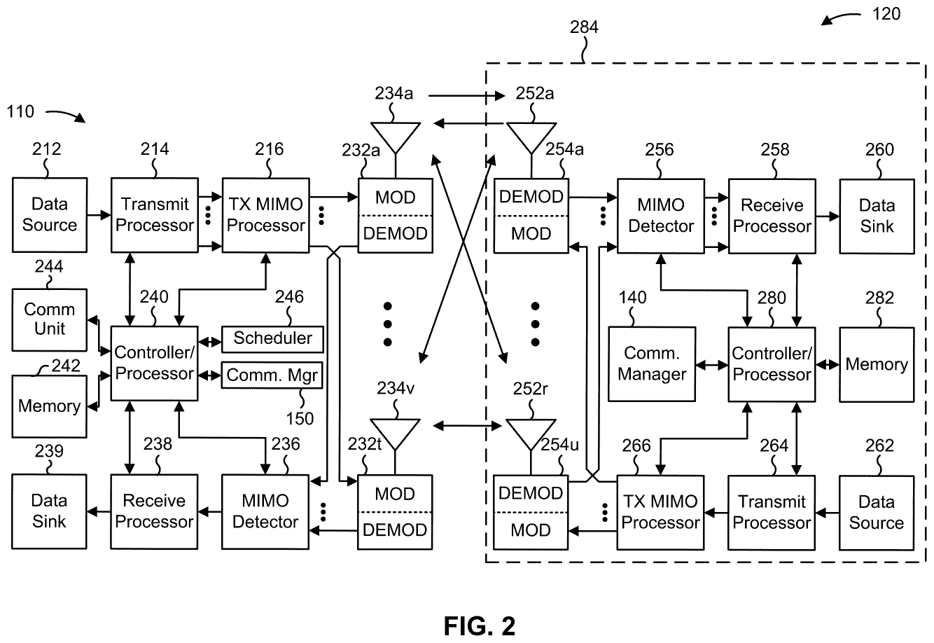

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

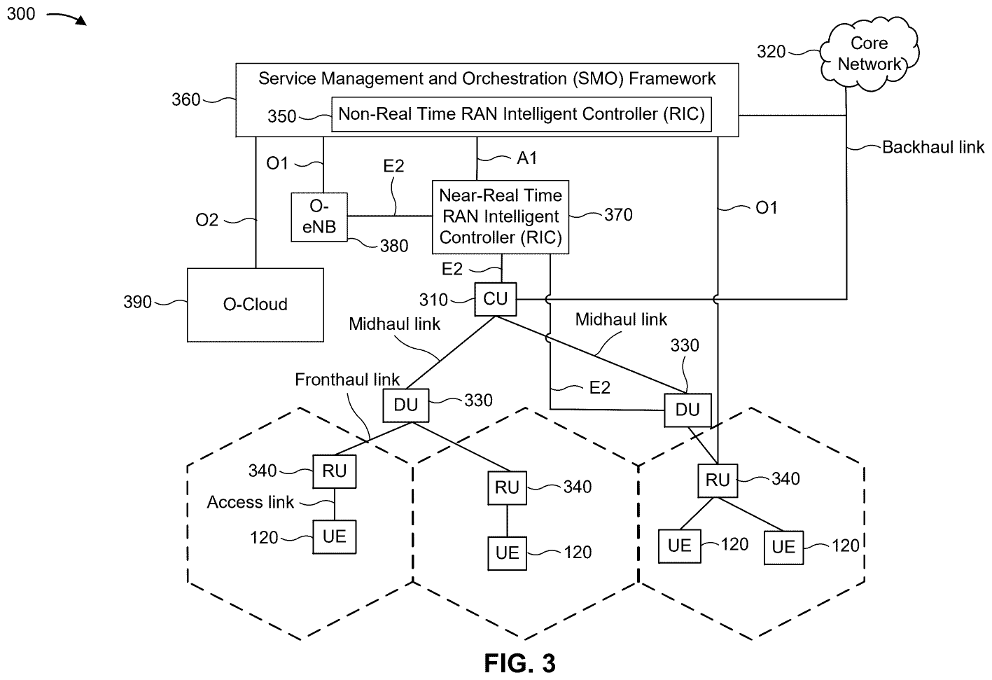

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the El interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an Al interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

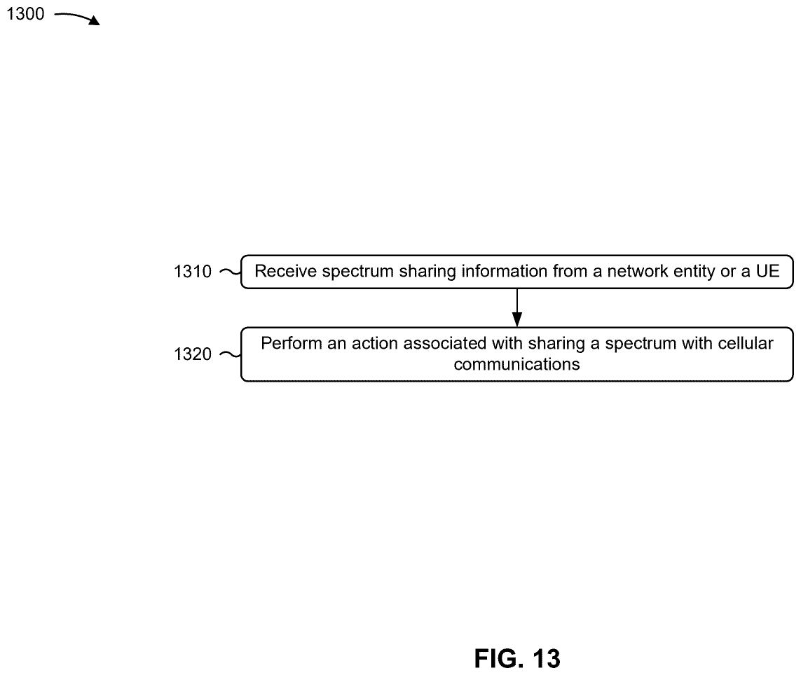

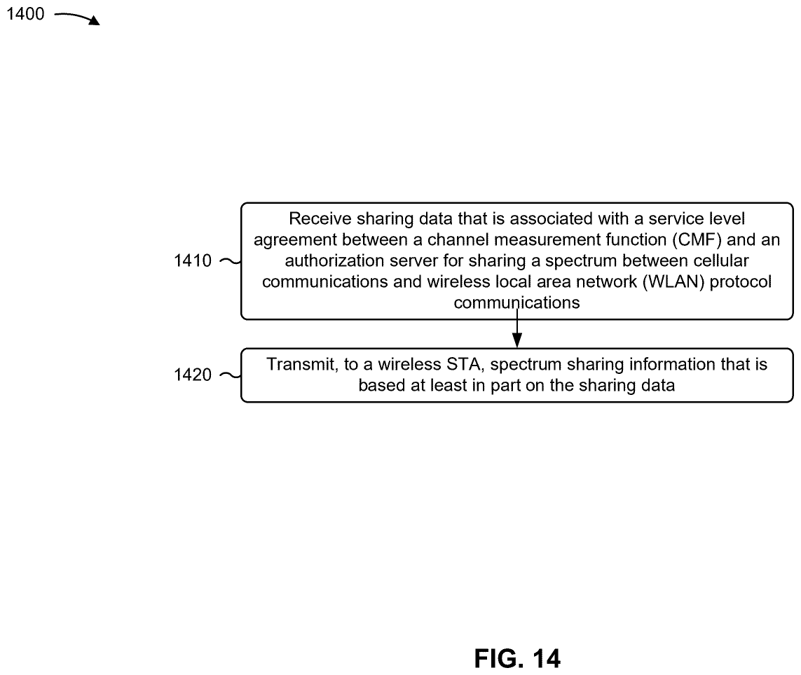

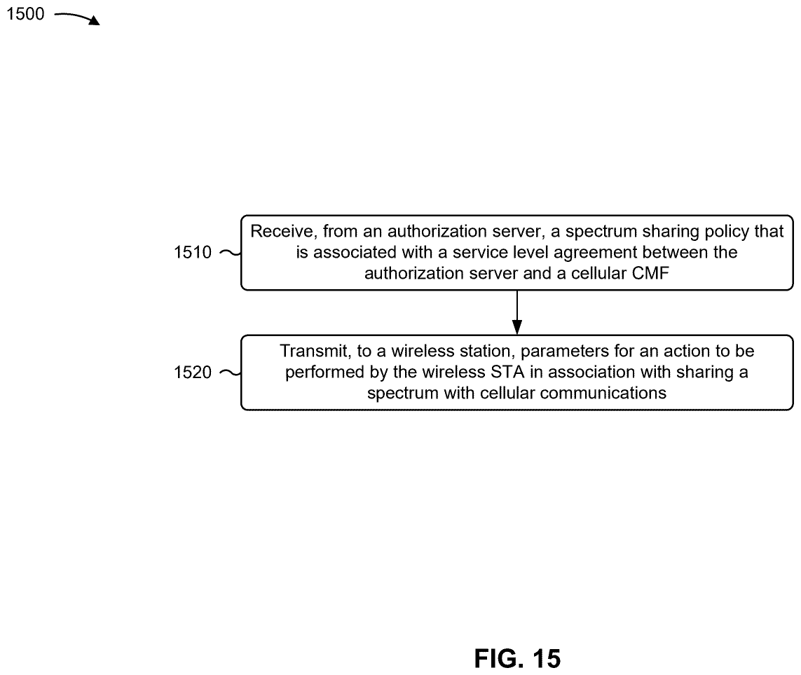

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with cross-technology spectrum sharing, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1300 of FIG. 13, process 1400 of FIG. 14, process 1500 of FIG. 15, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1300 of FIG. 13, process 1400 of FIG. 14, process 1500 of FIG. 15, or other processes as described herein. In some examples, executing instructions may include running the instructions, converting the instructions, compiling the instructions, and/or interpreting the instructions, among other examples.

As indicated above, FIG. 3 is provided as an example. Other examples may differ from what is described with regard to FIG. 3.

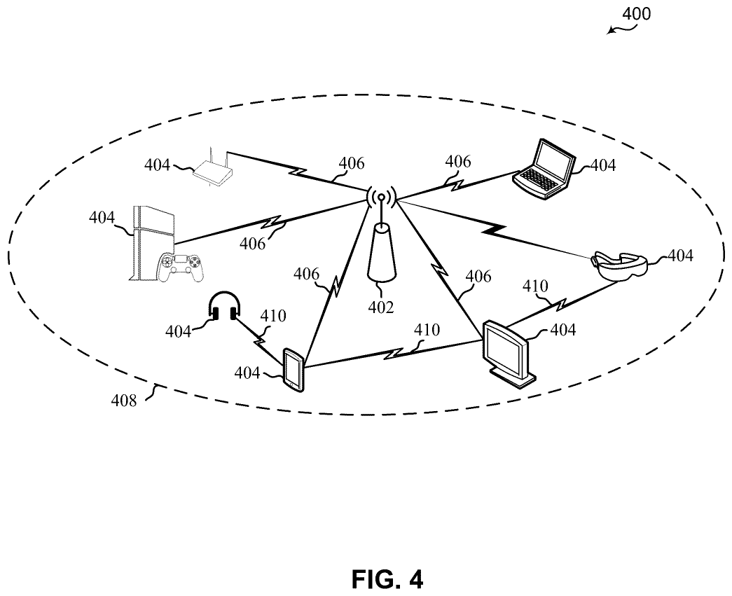

FIG. 4 shows a pictorial diagram of an example wireless communication network 400. According to some aspects, the wireless communication network 400 can be an example of a WLAN such as a Wi-Fi network. For example, the wireless communication network 400 can be a network implementing at least one of the IEEE 802.11 family of wireless communication (e.g., WLAN) protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 400 can be an example of a cellular radio access network (RAN), such as a 5G or 6G RAN that implements one or more cellular protocols such as those specified in one or more 3GPP standards. In some other examples, the wireless communication network 400 can include a WLAN that functions in an interoperable or converged manner with one or more cellular RANs to provide greater or enhanced network coverage to wireless communication devices within the wireless communication network 400 or to enable such devices to connect to a cellular network's core, such as to access the network management capabilities and functionality offered by the cellular network core. In some other examples, the wireless communication network 400 can include a WLAN that functions in an interoperable or converged manner with one or more personal area networks, such as a network implementing Bluetooth® technologies or other wireless technologies, to provide greater or enhanced network coverage or to provide or enable other capabilities, functionality, applications or services.

The wireless communication network 400 may include numerous wireless communication devices including a wireless access point (AP) 402 and any number of wireless stations (STAs) 404. While only one AP 402 is shown in FIG. 4, the wireless communication network 400 can include multiple APs 402 (for example, in an extended service set (ESS) deployment, enterprise network or AP mesh network), or may not include any AP at all (for example, in an independent basic service set (IBSS) such as a peer-to-peer (P2P) network or other ad hoc network). The AP 402 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 404 also may be referred to as a mobile station (MS), a mobile device, a mobile handset, a wireless handset, an access terminal (AT), a user equipment (UE), a subscriber station (SS), or a subscriber unit, among other examples. The STAs 404 may represent various devices such as mobile phones, other handheld or wearable communication devices, netbooks, notebook computers, tablet computers, laptops, Chromebooks, augmented reality (AR), virtual reality (VR), mixed reality (MR) or XR wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 402 and an associated set of STAs 404 may be referred to as an infrastructure basic service set (BSS), which is managed by the respective AP 402. FIG. 4 additionally shows an example coverage area 408 of the AP 402, which may represent a basic service area (BSA) of the wireless communication network 400. The BSS may be identified by STAs 404 and other devices by a service set identifier (SSID), as well as a basic service set identifier (BSSID), which may be a medium access control (MAC) address of the AP 402. The AP 402 may periodically broadcast beacon frames (“beacons”) including the BSSID to enable any STAs 404 within wireless range of the AP 402 to “associate” or re-associate with the AP 402 to establish a respective communication link 406 (hereinafter also referred to as a “Wi-Fi link”), or to maintain a communication link 406, with the AP 402. For example, the beacons can include an identification or indication of a primary channel used by the respective AP 402 as well as a timing synchronization function (TSF) for establishing or maintaining timing synchronization with the AP 402. The AP 402 may provide access to external networks to various STAs 404 in the wireless communication network 400 via respective communication links 406.

To establish a communication link 406 with an AP 402, each of the STAs 404 is configured to perform passive or active scanning operations (“scans”) on frequency channels in one or more frequency bands (for example, the 2.4 GHz, 5 GHZ, 6 GHZ, 45 GHz, or 60 GHz bands). To perform passive scanning, a STA 404 listens for beacons, which are transmitted by respective APs 402 at periodic time intervals referred to as target beacon transmission times (TBTTs). To perform active scanning, a STA 404 generates and sequentially transmits probe requests on each channel to be scanned and listens for probe responses from APs 402. Each STA 404 may identify, determine, ascertain, or select an AP 402 with which to associate in accordance with the scanning information obtained through the passive or active scans, and to perform authentication and association operations to establish a communication link 406 with the selected AP 402. The selected AP 402 assigns an association identifier (AID) to the STA 404 at the culmination of the association operations, which the AP 402 uses to track the STA 404.

As a result of the increasing ubiquity of wireless networks, a STA 404 may have the opportunity to select one of many BSSs within range of the STA 404 or to select among multiple APs 402 that together form an extended service set (ESS) including multiple connected BSSs. For example, the wireless communication network 400 may be connected to a wired or wireless distribution system that may enable multiple APs 402 to be connected in such an ESS. As such, a STA 404 can be covered by more than one AP 402 and can associate with different APs 402 at different times for different transmissions. Additionally, after association with an AP 402, a STA 404 also may periodically scan its surroundings to find a more suitable AP 402 with which to associate. For example, a STA 404 that is moving relative to its associated AP 402 may perform a “roaming” scan to find another AP 402 having more desirable network characteristics such as a greater received signal strength indicator (RSSI) or a reduced traffic load.

In some examples, STAs 404 may form networks without APs 402 or other equipment other than the STAs 404 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 400. In such examples, while the STAs 404 may be capable of communicating with each other through the AP 402 using communication links 406, STAs 404 also can communicate directly with each other via direct wireless communication links 410. Additionally, two STAs 404 may communicate via a direct wireless communication link 410 regardless of whether both STAs 404 are associated with and served by the same AP 402. In such an ad hoc system, one or more of the STAs 404 may assume the role filled by the AP 402 in a BSS. Such a STA 404 may be referred to as a group owner (GO) and may coordinate transmissions within the ad hoc network. Examples of direct wireless communication links 410 include Wi-Fi Direct connections, connections established by using a Wi-Fi Tunneled Direct Link Setup (TDLS) link, and other P2P group connections.

In some networks, the AP 402 or the STAs 404, or both, may support applications associated with high throughput or low-latency requirements, or may provide lossless audio to one or more other devices. For example, the AP 402 or the STAs 404 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 402 or the STAs 404 may support an extended personal audio network enabling communication with the two or more peripheral devices. Additionally, the AP 402 and STAs 404 may support additional ULL applications such as cloud-based applications (such as VR cloud gaming) that have ULL and high throughput requirements.

As indicated above, in some implementations, the AP 402 and the STAs 404 may function and communicate (via the respective communication links 406) according to one or more of the IEEE 802.11 family of wireless communication protocol standards. These standards define the WLAN radio and baseband protocols for the physical (PHY) and MAC layers. The AP 402 and STAs 404 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 402 and STAs 404 in the wireless communication network 400 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some examples of the APs 402 and STAs 404 described herein also may communicate in other frequency bands that may support licensed or unlicensed communications. For example, the APs 402 or STAs 404, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

As indicated above, FIG. 4 is provided as an example. Other examples may differ from what is described with regard to FIG. 4.

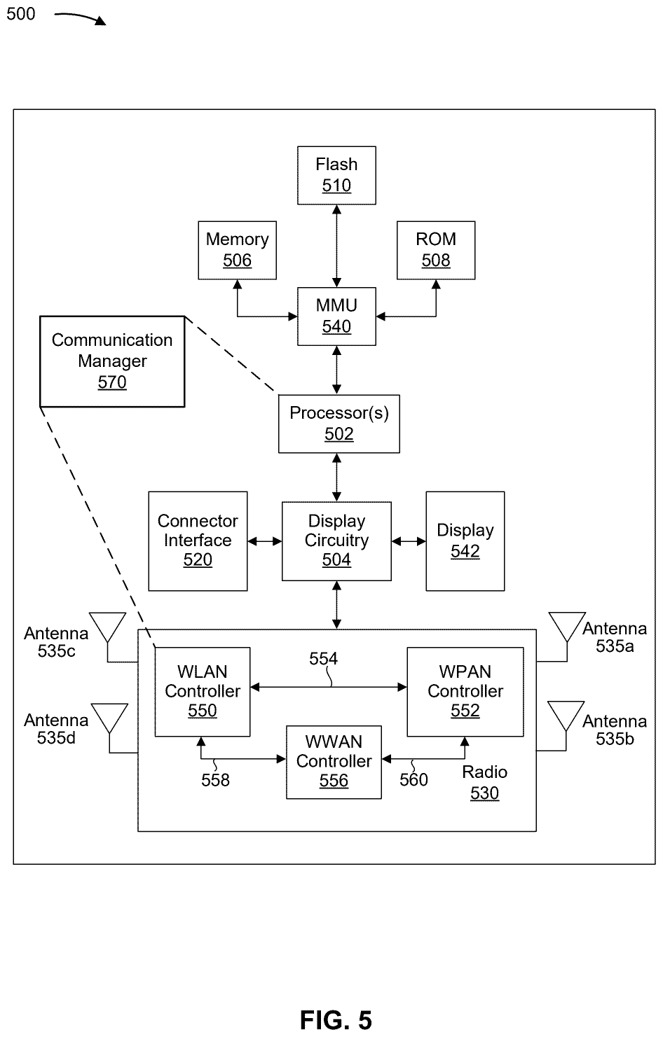

FIG. 5 is a diagram illustrating an example of a wireless communication device 500, in accordance with the present disclosure. In some aspects, the wireless communication device 500 may be a central device, a peripheral device, a Wi-Fi device, or a Bluetooth-enabled device (such as a Bluetooth low energy (BLE) device).

As shown in FIG. 5, the wireless communication device 500 may include a processing element, such as processor(s) 502, which may execute program instructions for the wireless communication device 500. The wireless communication device 500 may also include a display 542 that can perform graphics processing and present information to a user. The processor(s) 502 may also be coupled to a memory management unit (MMU) 540, which may be configured to receive addresses from the processor(s) 502 and translate the addresses to address locations in memory such as memory 506, ROM 508, or flash memory 510 and/or to address locations in other circuits or devices, such as display circuitry 504, radio 530, connector interface 520, and/or display 542. The MMU 540 may also be configured to perform memory protection and page table translation or set up. In some aspects, the MMU 540 may be included as a portion of the processor(s) 502.

The processor(s) 502 may be coupled to other circuits of the wireless communication device 500. For example, the wireless communication device 500 may include various memory types, a connector interface 520 through which the wireless communication device 500 can communicate with a computer system, and wireless communication subsystems that can transmit data to, and receive data from, other devices based on one or more wireless communication standards or protocols. For example, in some aspects, the wireless communication subsystems may include (but are not limited to) a WLAN subsystem, a wireless personal area network (WPAN) subsystem, and/or a cellular subsystem (such as a Long-Term Evolution (LTE) or NR subsystem). The wireless communication device 500 may include multiple antennas 535a, 535b, 535c, and/or 535d for performing wireless communication with, for example, wireless communication devices in a WPAN. In some aspects, the WPAN may be an extended PAN (XPAN).

The wireless communication device 500 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware clement, such as an FPGA, and/or an ASIC.

In some aspects, the radio 530 may include separate controllers configured to control communications for various respective RAT protocols. For example, as shown in FIG. 5, radio 530 may include a WLAN controller 550 that manages WLAN communications, a WPAN controller 552 that manages Bluetooth, BLE, and/or other suitable WPAN communications, and a wireless wide area network (WWAN) controller 556 that manages WWAN communications. In some aspects, the wireless communication device 500 may store and execute a WLAN software driver for controlling WLAN operations performed by the WLAN controller 550, a WPAN software driver for controlling WPAN operations performed by the WPAN controller 552, and/or a WWAN software driver for controlling WWAN operations performed by the WWAN controller 556.

In some aspects, a first coexistence interface 554 (such as a wired interface) may be used for sending information between the WLAN controller 550 and the WPAN controller 552. Additionally, or alternatively, in some aspects, a second coexistence interface 558 may be used for sending information between the WLAN controller 550 and the WWAN controller 556. Additionally, or alternatively, in some aspects, a third coexistence interface 560 may be used for sending information between the WPAN controller 552 and the WWAN controller 556.

In some aspects, one or more of the WLAN controller 550, the WPAN controller 552, and/or the WWAN controller 556 may be implemented as hardware, software, firmware, or any suitable combination thereof.

In some aspects, the WLAN controller 550 may be configured to communicate with a second device in a WPAN using a WLAN link using one or more, some, or all of the antennas 535a, 535b, 535c, and 535d. In other configurations, the WPAN controller 552 may be configured to communicate with at least one second device in a WPAN using one or more, some, or all of the antennas 535a, 535b, 535c, and 535d. In other configurations, the WWAN controller 556 may be configured to communicate with a second device in a WPAN using one or more, some, or all of the antennas 535a, 535b, 535c, and 535d. The WLAN controller 550, the WPAN controller 552, and/or the WWAN controller 556 may be configured to adjust a wakeup time interval and a shutdown time for the wireless communication device 500.

A short-range wireless communications protocol, such as a Bluetooth (BT) protocol, BLE, and/or basic rate (BR)/enhanced data rate (EDR), may include and/or may use one or more other communications protocols, for example, to establish and maintain communications links. The wireless communication device 500 may establish a communications link with one or more peripheral devices, such as a wireless headset, according to at least one communications protocol for short-range wireless communications. In some aspects, the communications link may include a communications link that adheres to a protocol included and/or for use with BT, BLE, BR/EDR, or the like. In one aspect, the communications link may include an asynchronous connection-oriented logical (ACL) transport, sometimes referred to as an ACL link. When operating as an ACL link, the communications link may allow the central device (e.g., a source device) to connect or “pair” with a peripheral device, such as the headset. The connection is asynchronous in that the two devices may not need to synchronize, timewise, data communications between each other to permit communication of data packets via the communications link.

In some aspects, a wireless station (e.g., a wireless communication device 500, a mobile station) may include a communication manager 570. As described in more detail elsewhere herein, the communication manager 570 may receive spectrum sharing information from a cellular entity. The communication manager 570 may perform an action associated with sharing a spectrum with cellular communications. Additionally, or alternatively, the communication manager 570 may perform one or more other operations described herein.

In some aspects, a cellular entity (e.g., a UE 120, a network node 110) may include a communication manager 140 or 150. As described in more detail elsewhere herein, the communication manager 140 or 150 may receive sharing data that is associated with a service level agreement between a cellular CMF and a non-cellular authorization server for sharing a spectrum between cellular communications and non-cellular communications. The communication manager 140 or 150 may transmit, to a wireless station, spectrum sharing information that is based at least in part on the sharing data. Additionally, or alternatively, the communication manager 140 or 150 may perform one or more other operations described herein.

In some aspects, an access point (e.g., a wireless communication device 500) may include a communication manager 570. As described in more detail elsewhere herein, the communication manager 570 may receive, from a non-cellular authorization server, a spectrum sharing policy that is associated with a service level agreement between the non-cellular authorization server and a cellular CMF. The communication manager 570 may transmit, to a wireless station, parameters for an action to be performed by the wireless station in association with sharing a spectrum with cellular communications. Additionally, or alternatively, the communication manager 570 may perform one or more other operations described herein.

In some aspects, a wireless STA (e.g., wireless communication device 500, mobile station, STA 404) includes means for receiving spectrum sharing information from a cellular entity; and/or means for performing an action associated with sharing a spectrum with cellular communications. In some aspects, the means for the wireless STA to perform operations described herein may include, for example, one or more of communication manager 570, processor 502, WLAN controller 550, radio 530, antennas 535a-535d, or memory 506.

In some aspects, a cellular entity (e.g., UE 120, network node 110) includes means for receiving sharing data that is associated with a service level agreement between a CMF and an authorization server for sharing a spectrum between cellular communications and WLAN protocol communications; and/or means for transmitting, to a wireless STA, spectrum sharing information that is based at least in part on the sharing data. In some aspects, the means for the cellular entity to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246. In some aspects, the means for the cellular entity to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a wireless AP (e.g., wireless communication device 500, AP 402) includes means for receiving, from an authorization server, a spectrum sharing policy that is associated with a service level agreement between the authorization server and a CMF; and/or means for transmitting, to a wireless STA, parameters for an action to be performed by the wireless STA in association with sharing a spectrum with cellular communications. In some aspects, the means for the wireless AP to perform operations described herein may include, for example, one or more of communication manager 570, processor 502, WLAN controller 550, radio 530, antennas 535a-535d, or memory 506.

As indicated above, FIG. 5 is provided as an example. Other examples may differ from what is described with regard to FIG. 5.

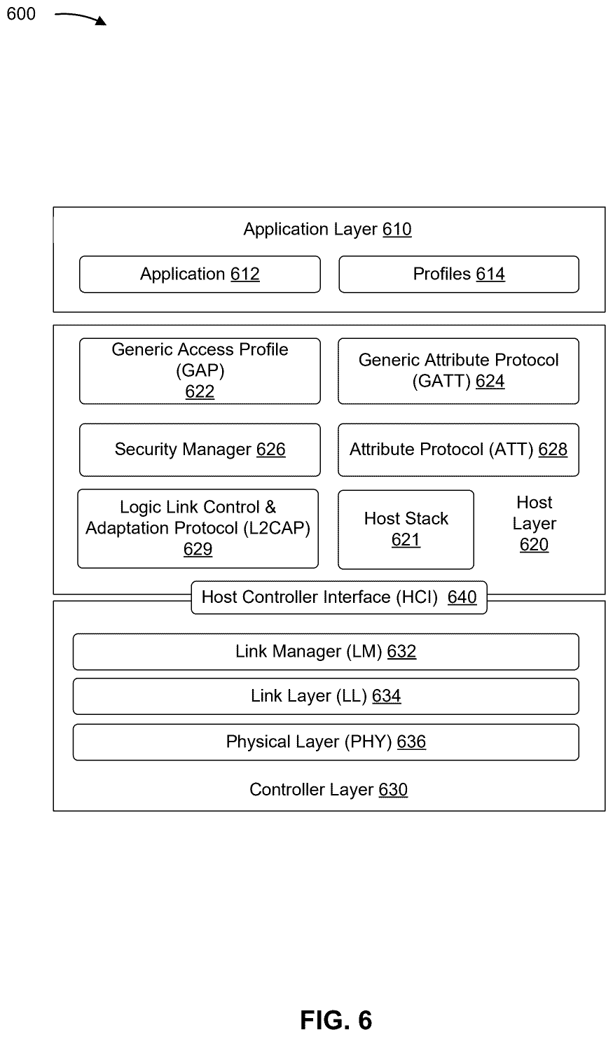

FIG. 6 is a diagram illustrating an example 600 of a protocol stack (e.g., a WPAN and/or a Bluetooth protocol stack), in accordance with the present disclosure. In some aspects, the protocol stack 600 may be implemented in a wireless communication device (such as the central device or one or more peripheral devices). For example, the protocol stack 600 may be implemented by one or more of processor(s) 502, memory 506, flash memory 510, ROM 508, the radio 530, and/or the WPAN controller 552 illustrated in FIG. 5. In some aspects, the protocol stack 600 may be organized into three layers that include an application layer 610, a host layer 620, and a controller layer 630.

In some aspects, the application layer 610 may be a user application layer that interfaces with the other blocks and/or layers of the protocol stack 600. In some aspects, the application layer 610 may include one or more applications 612 and one or more Bluetooth profiles 614 that allow the one or more applications 612 to use Bluetooth and/or BLE communications. The host layer 620 may include the upper layers of the protocol stack 600, and may communicate with a controller (such as the WPAN controller 552 of FIG. 5) in a wireless communication device using a host controller interface (HCl) 640. In some aspects, the host layer 620 may include a host stack 621 that can be used for application layer interface management to allow an application 612 to access WPAN communications.

The controller layer 630 may include the lower layers of the protocol stack 600. In some aspects, the controller layer 630 may be used for hardware interface management, link establishment, and link management. As shown in FIG. 6, the controller layer 630 may include a link manager (LM) 632, a link layer 634, and a PHY layer 636. The PHY layer 636 may include, for example, a radio and/or a baseband processor. In some aspects, the PHY layer 636 may define a mechanism for transmitting a bit stream over a physical link or channel that connects WPAN devices. The bit stream may be grouped into code words or symbols, and may be converted to a data packet that is transmitted over a wireless transmission medium. The PHY layer 636 may provide an electrical, mechanical, and/or procedural interface to the wireless transmission medium. The PHY layer 636 may be responsible for modulation and demodulation of data into RF signals for transmission over the air. The PHY layer 636 may describe the physical characteristics of a transmitter/receiver (or transceiver) included in a wireless communication device. The physical characteristics may include modulation characteristics, an RF tolerance, and/or a sensitivity level, among other examples.

In some aspects, the link layer 634 is responsible for low-level communication over the PHY layer 636. The link layer 634 may manage the sequence and timing for transmitting and receiving data packets, and using a link layer (LL) protocol, communicates with other devices regarding connection parameters and data flow control. The link layer 634 also provides gatekeeping functionality to limit exposure and data exchange with other devices. If filtering is configured, the link layer 634 maintains a list of allowed devices and may ignore all requests for data exchange from devices not on the list of allowed devices. The link layer 634 may also reduce power consumption. In some aspects, the link layer 634 may include a proprietary LL that may be used to discover peer devices, and establish a secure communication channel with the peer devices. In some aspects, the link layer 634 may be responsible for transporting data packets between devices in a WPAN. Each data packet may include an access address, which specifies the type of logical transport used to carry the data packet. Logical transports may exist between a master device and slave devices. Additionally, some logical transports may carry multiple logical links.

The link manager 632 may be responsible for establishing and configuring links and managing power-change requests, among other tasks. Each type of logical link, such as ACL links, advanced audio distribution profile (A2DP) links, synchronous connection-oriented (SCO) links, extended SCO (eSCO) links, isochronous (ISO) links, or the like, may be associated with a specific packet type. For example, an SCO link may provide reserved channel bandwidth for communication between a central device and a peripheral device, and may support regular, periodic exchange of data packets with no retransmissions. An eSCO link may provide reserved channel bandwidth for communication between a source device and a peripheral device, and support regular, periodic exchange of data packets with retransmissions. An ACL link may exist between a source device and a peripheral device from the beginning of establishment of a connection between the source device and the peripheral device, and the data packets for ACL links may include encoding information in addition to a payload.

The link manager 632 may communicate with the host layer 620 using the HCl 640. In some aspects, the link manager 632 may translate commands associated with the HCl 640 into controller-level operations, such as baseband-level operations. The HCl 640 may act as a boundary between the lower layers (such as between the controller layer 630, the host layer 620, and the application layer 610). The BT specification may define a standard HCl to support BT systems that are implemented across two separate processors. For example, a BT system on a computer may use a processor of the BT system to implement the lower layers of the protocol stack 600, such as the PHY layer 636, the link layer 634, and/or the link manager 632, and may use a processor of a BT component to implement the other layers of the protocol stack 600, such as the host layer 620 and the application layer 610.

In FIG. 6, the host layer 620 is shown to include a generic access profile (GAP) 622, a generic attribute protocol (GATT) 624, a security manager (SM) 626, an attribute protocol (ATT) 628, and an logical link control and adaptation protocol (L2CAP) layer 629. The GAP 622 may provide an interface for an application 612 to initiate, establish, and manage connections with other WPAN (e.g., BT or BLE) devices. The GATT 624 may provide a service framework using the attribute protocol for discovering services, and for reading and writing characteristic values on a peer device. The GATT 624 may interface with the application 612, for example, through a profile which may define a collection of attributes and any permissions needed for the attributes to be used in BT or BLE communications.

The security manager 626 may be responsible for device pairing and key distribution. A security manager protocol implemented by the security manager 626 may define how communications with the security manager of a counterpart BLE device are performed. The security manager 626 provides additional cryptographic functions that may be used by other components of the protocol stack 600. The architecture of the security manager 626 used in WPAN communications is designed to minimize recourse requirements for peripheral devices by shifting work to a presumably more powerful central device. BLE uses a pairing mechanism for key distribution. The security manager 626 provides a mechanism to encrypt the data and a mechanism to provide data authentication.

The ATT 628 includes a client/server protocol based on attributes associated with a BLE device configured for a particular purpose. Examples may include monitoring heart rate, temperature, broadcasting advertisements, or the like. The attributes may be discovered, read, and written by peer devices. The set of operations which are executed over the ATT 628 may include error handling, server configuration, find information, read operations, write operations, and/or queued writes. The ATT 628 may form the basis of data exchange between BT and BLE devices.

The L2CAP layer 629 may be implemented above the HCl 640, and may communicate with the controller layer 630 through the HCl 640. The L2CAP layer 629 may be responsible for establishing connections across one or more existing logical links and for requesting additional links if none exist. The L2CAP layer 629 may also implement multiplexing between different higher-layer protocols, for example, to allow different applications to use a single link, such as a logical link, including an ACL link. In some implementations, the L2CAP layer 629 may encapsulate multiple protocols from the upper layers into a data packet format (and vice versa). The L2CAP layer 629 may also break packets with a large data payload from the upper layers into multiple packets with the data payload segmented into smaller size data payloads that fit into a maximum payload size (for example, twenty-seven (27) bytes) on the transmit side.

In some standards and protocols, such as BLE and/or BR/EDR, the central device may detect errors in a packet and/or a dropped/missed/not received packet through the use of cyclic redundancy check (CRC) validation and through the use of message integrity code (MIC) validation. MIC validation may be used when a packet is encrypted. For example, failure of CRC validation may indicate one or more errors in a received packet, and failure of MIC validation may indicate that another packet has not been received (although failure of CRC validation may also indicate that another packet has not been received, and/or failure of MIC validation may also indicate one or more errors in a received packet).

CRC validation and MIC validation may be based on generating CRC values and MICs, respectively, based on received packets and respectively comparing those generated CRC values and MICs to CRC values and MICs included in the received packets. Specifically, a receiving device, such as a headset, that receives a packet may first generate a CRC value or a CRC checksum based on the received packet, such as based on a payload and, if applicable, an MIC included in the received packet. The receiving device may compare the generated CRC value with a CRC value included in the received packet. If the generated CRC value matches the CRC value included in the received packet, then the received packet may be validated for CRC. The CRC-validated received packet may then be decrypted. However, if the generated CRC value does not match the CRC value included in the received packet, then the receiving device may determine that the received packet fails CRC validation. If the receiving device determines that the received packet fails CRC validation, then the received packet may include errors and/or may be corrupted. In one configuration, the receiving device may discard the received packet that fails CRC validation. Alternatively, in another configuration, the receiving device may attempt to recover the received packet, for example, using one or more error correction techniques.

If the received packet is encrypted and passes CRC validation, then the receiving device may decrypt the received packet to obtain a decrypted payload and a decrypted MIC. For MIC validation, the receiving device may generate an MIC based on the decrypted payload, and compare the generated MIC with the MIC obtained from the decrypted received packet. If the generated MIC matches the decrypted MIC, then the receiving device may determine that the received packet is successfully decrypted. When the received packet is successfully decrypted, the decoded and decrypted payload of the received packet may be provided to another layer of the receiving device, such as a coder-decoder (codec) of the receiving device that may cause the payload data of the received packet to be output by the receiving device, for example, as audio through speakers of the headset.

If the generated MIC does not match the decrypted MIC of the received packet, then the receiving device may determine that the received packet is unsuccessfully decrypted. When the received packet is unsuccessfully decrypted, then a different packet may have been missed or the received packet may be erroneous or otherwise corrupted. In one configuration, the receiving device may discard the received packet that fails MIC validation. Alternatively, in another configuration, the receiving device may attempt to recover the received packet.

As indicated above, FIG. 6 is provided as an example. Other examples may differ from what is described with regard to FIG. 6.

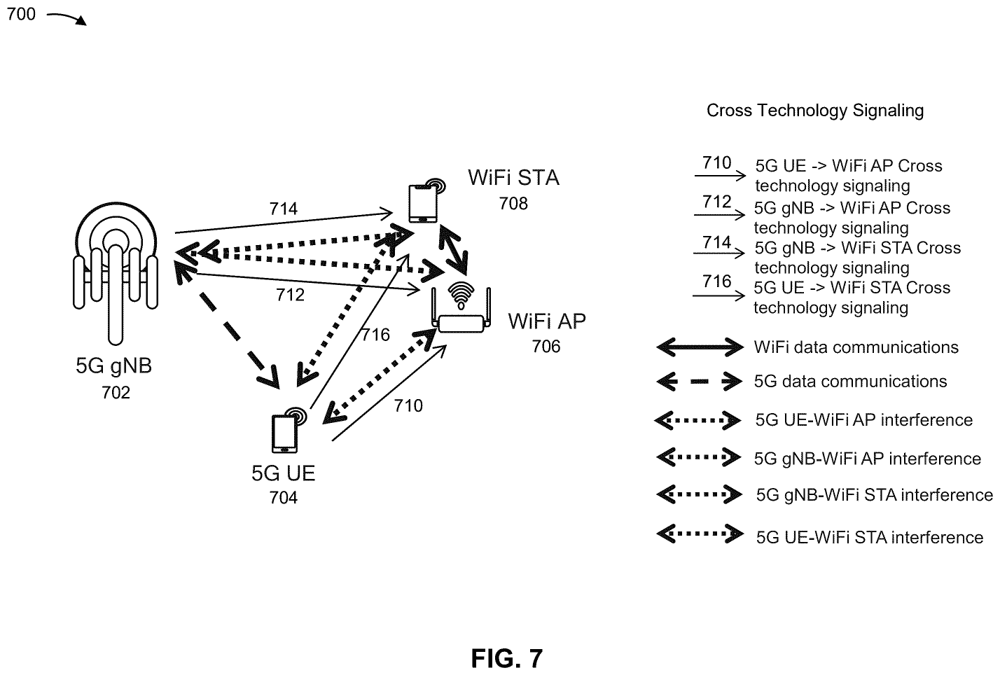

FIG. 7 is a diagram illustrating an example 700 of cross-technology sharing, in accordance with the present disclosure.

In some scenarios, different technologies, such as high power macro cellular (e.g., 5G/6G) and Wi-Fi (e.g., IEEE 802.11bc), may share a spectrum (e.g., 3.5 GHZ, 6 GHz) in a hybrid sharing framework. The spectrum is expected to be shared such that there are no restrictions on the cellular transmit power. Example 700 shows communications between cellular entities (e.g., 5G gNB 702 or 5G UE 704) and non-cellular entities (e.g., Wi-Fi AP, Wi-Fi mobile station (STA) 708), as well as the interference that may affect the communications. Interference degrades communications, which decreases throughput, wastes signaling resources, and increases latency.

According to various aspects described herein, the cellular entities (e.g., 5G gNB 702, 5G UE 704) may utilize a Wi-Fi waveform for cross-technology signaling. For example, the 5G UE 704 may transmit (e.g., discontinuous transmission (DTX)) cross-technology signaling, such as spectrum sharing information, to the Wi-Fi STA 708 that indicates how the Wi-Fi STA 708 is to operate in the shared spectrum. The 5G UE 704 may transmit the spectrum sharing information in 5G downlink (D) slots and transmit without performing a listen-before-talk (LBT) procedure to determine if the channel is clear.

When the Wi-Fi STA 708 receives the spectrum sharing information, the Wi-Fi STA 708 may perform an action associated with sharing a spectrum with cellular communications (transmissions be the cellular entities). The spectrum sharing information may indicate the action or include parameters for the action. In some aspects, the action may include limiting non-cellular communications to a portion of the spectrum. The parameters may indicate the portion. In some aspects, the action may include reducing power for non-cellular communications of the Wi-Fi STA 708 in the spectrum. The parameters may indicate an amount that the power is to be reduced. In some aspects, the action may include time domain sharing with cellular communications in the spectrum. The parameters may indicate a pattern for the time domain sharing.

By receiving cross-technology signaling from a cellular entity and performing an action based at least in part on the cross-technology signaling, the Wi-Fi STA 708 may improve the sharing of the spectrum with cellular entities. As a result, throughput increases from both cellular entities and non-cellular entities using the shared spectrum, signaling resources that do not collide are conserved, and latency from retransmission is reduced.

Example 700 shows cross-technology signaling 710 that may take place between the 5G UE 704 and a Wi-Fi AP 706, cross-technology signaling 712 that may take place between the 5G gNB 702 and the Wi-Fi AP 706, cross-technology signaling 714 that may take place between the 5G gNB 702 and a wireless station (e.g., a Wi-Fi STA 708), and cross-technology signaling 716 that may take place between the 5G UE 704 and the Wi-Fi STA 708.

In some aspects, the 5G UE 704 may be configured with dual subscriber identity module (SIM) single active (DSSA) gaps to periodically “tune-out” and transmit cross-technology signaling. The 5G UE 704 may also be configured for multi-SIM or multi-universal SIM (MUSIM) operation. The 5G UE 704 may also utilize dynamic capability signaling for dual SIM dual active (DSDA) operation if connected on another carrier frequency with the 5G gNB 702.

In some aspects, the Wi-Fi STA 708 may receive a configuration for forwarding the spectrum sharing information to the Wi-Fi AP 706. The Wi-Fi STA 708 may forward the spectrum sharing information to the Wi-Fi AP 706, and the Wi-Fi AP 706 may indicate an action and/or parameters for the action to the Wi-Fi-STA 708 for spectrum sharing.

As indicated above, FIG. 7 is provided as an example. Other examples may differ from what is described with regard to FIG. 7.

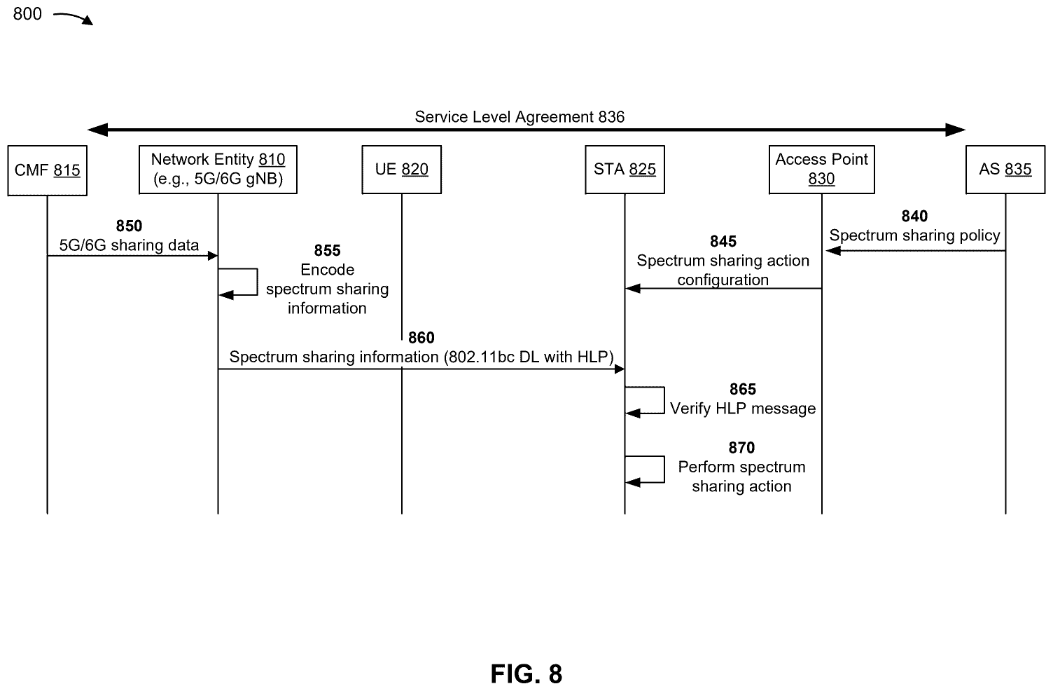

FIG. 8 is a diagram illustrating an example 800 of cross-technology signaling, in accordance with the present disclosure. Example 800 shows an authorization server (AS) 835 (e.g., wireless communication device 500) and a channel management function (CMF) 815 (e.g., network node 110) that negotiates a service level agreement 836 between a cellular network and a non-cellular network. The AS 835 may control the access of non-cellular entities. The CMF 815 may manage channels for cellular entities. A network entity 810 (e.g., network node 110, 5G/6G gNB) may communicate with the CMF 815 and a UE 820 (e.g., UE 120). A Wi-Fi AP 830 may communicate with a Wi-Fi STA 825 and the AS 835. In some aspects, the network entity 810 and/or the UE 820 may communicate with the STA 825 and/or the AP 830.

The AS 835 may obtain or generate a spectrum sharing policy for how non-cellular entities are to share a spectrum with cellular entities. As shown by reference number 840, the AS 835 may transmit a spectrum sharing policy to the AP 830. As shown by reference number 845, the AP 830 may transmit a spectrum sharing action configuration to the STA 825 that configures one or more actions that the STA 825 may take to share a spectrum with communications by cellular entities. The CMF 815 may generate 5G/6G sharing data for how cellular entities can share a spectrum with non-cellular entities to comply with the service level agreement 836. As shown by reference number 850, the CMF 815 may transmit the sharing data to the network entity 810.

Example 800 shows cross-technology signaling from the network entity 810 to the STA 825, which is preconfigured to perform an action to share the spectrum. As shown by reference number 855, the network entity 810 may encode spectrum sharing information based at least in part on the sharing data. As shown by reference number 860, the network entity 810 may transmit the spectrum sharing information in a higher layer protocol (HLP) message using a Wi-Fi protocol (e.g., IEEE 802.11bc). The IEEE 802.11bc waveform may be a transport mechanism. In some aspects, the network entity 810 may downlink broadcast the HLP message. The STA 825 may detect and receive the HLP message. As shown by reference number 865, the STA 825 may verify the HLP message.

As shown by reference number 870, the STA 825 may perform on action configured by the AP 830 to share the spectrum with cellular entities, such as network entity 810 and/or UE 820. The action may include limiting operation to a part of the spectrum, reducing transmit power, and/or time domain sharing. Cross-technology collisions are minimized and the spectrum is better utilized by both technologies.

As indicated above, FIG. 8 is provided as an example. Other examples may differ from what is described with regard to FIG. 8.

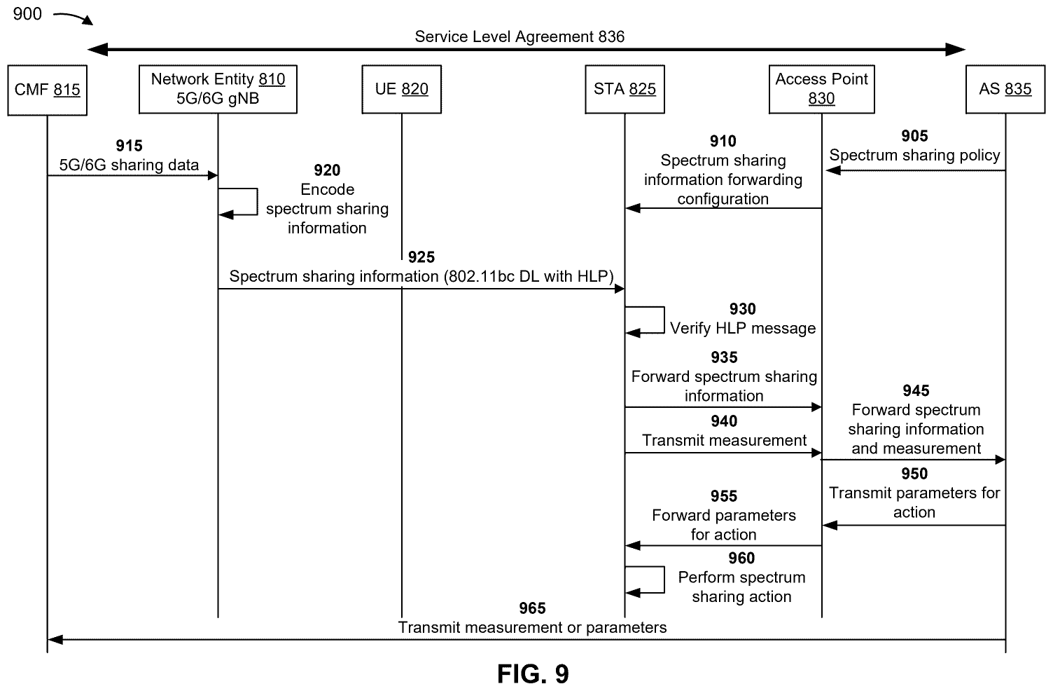

FIG. 9 is a diagram illustrating an example 900 of cross-technology signaling, in accordance with the present disclosure.

As shown by reference number 905, the AS 835 may transmit a spectrum sharing policy to the AP 830. As shown by reference number 910, the AP 830 may transmit a configuration for forwarding spectrum sharing information to the AP 830. As shown by reference number 915, the CMF 815 may transmit sharing data to the network entity 810.

Example 900 shows cross-technology signaling from the network entity 810 to the STA 825, where the AP 830 and/or the AS 835 decides the action the STA 825 is to perform in order to better share the spectrum. As shown by reference number 920, the network entity 810 may encode spectrum sharing information based at least in part on the sharing data. As shown by reference number 925, the network entity 810 may transmit the spectrum sharing information in an HLP message. The STA 825 may detect and receive the HLP message. As shown by reference number 930, the STA 825 may verify the HLP message.

As shown by reference number 935, the STA 825 may forward the spectrum sharing information to the AP 830. In some aspects, as shown by reference number 940, the STA 825 may also transmit a measurement, such as a measurement of a reference signal (e.g., signal strength, signal quality). As shown by reference number 945, the AP 830 may forward the spectrum sharing information to the AS 835. The AP 830 may also forward the measurement and any certificate associated with verification of the HLP message. The AS 835 may receive the spectrum sharing information and/or the measurement information. The AS 835 may determine an action and/or parameters for the action (or an action already configured at the STA 825) for sharing the spectrum. As shown by reference number 950, the AS 835 may transmit parameters for the action (or the action itself) to the AP 830. In some aspects, the parameters may reconfigure a channel configuration of the AP 830 As shown by reference number 955, the AP 830 may forward the parameters (or action) to the STA 825.

As shown by reference number 960, the STA 825 may perform on action configured by the AP 830 to share the spectrum with cellular entities, such as network entity 810 and/or UE 820. The action may include limiting operation to a part of the spectrum, reducing transmit power, and/or time domain sharing. Cross-technology collisions are minimized and the spectrum is better utilized by both technologies. In some aspects, as shown by reference number 965, the AS 835 may transmit the measurement and/or the parameters to the CMF 815 in association with the cooperative service level agreement 836. The CMF 815 may use the measurement and/or parameters to transmit any new sharing data to the cellular entities. The CMF 815 may reconfigure 5G/6G channel parameters.

As indicated above, FIG. 9 is provided as an example. Other examples may differ from what is described with regard to FIG. 9.

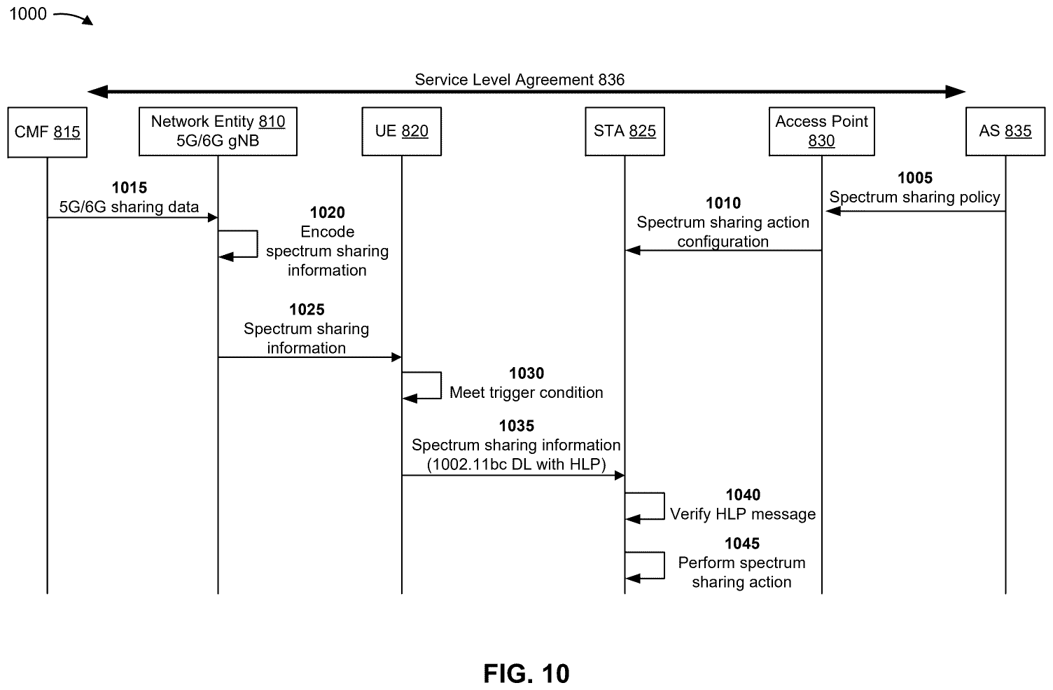

FIG. 10 is a diagram illustrating an example 1000 of cross-technology signaling, in accordance with the present disclosure.

The AS 835 may obtain or generate a spectrum sharing policy for how non-cellular entities are to share a spectrum with cellular entities. As shown by reference number 1005, the AS 835 may transmit a spectrum sharing policy to the AP 830. As shown by reference number 1010, the AP 830 may transmit a spectrum sharing action configuration to the STA 825 that configures one or more actions that the STA 825 may take to share a spectrum with communications by cellular entities. The CMF 815 may generate 5G/6G sharing data for how cellular entities can share a spectrum with non-cellular entities. As shown by reference number 1015, the CMF 815 may transmit the sharing data to the network entity 810.

Example 1000 shows cross-technology signaling from the UE 820 to the STA 825, which is preconfigured to perform an action to share the spectrum. As shown by reference number 1020, the network entity 810 may encode spectrum sharing information based at least in part on the sharing data. As shown by reference number 1025, the network entity 810 may transmit the spectrum sharing information to the UE 820.

The UE 820 may detect that some event has met a trigger condition, as shown by reference number 1030. For example, a signal strength of non-cellular communications in the spectrum may satisfy a threshold (e.g., RSRP meets or exceeds an RSRP threshold) or a quantity of non-cellular communications in the spectrum may satisfy a threshold (e.g., minimum quantity of non-cellular communications). As shown by reference number 1035, the UE 820 may transmit the spectrum sharing information based at least in part on the trigger condition being met. The UE 820 may transmit the spectrum sharing information in an HLP message using a Wi-Fi protocol (e.g., IEEE 802.11bc). The STA 825 may detect and receive the HLP message. As shown by reference number 1040, the STA 825 may verify the HLP message.

As shown by reference number 1045, the STA 825 may perform on action configured by the AP 830 to share the spectrum with cellular entities, such as network entity 810 and/or UE 820. The action may include limiting operation to a part of the spectrum, reducing transmit power, and/or time domain sharing. Cross-technology collisions are minimized and the spectrum is better utilized by both technologies.

As indicated above, FIG. 10 is provided as an example. Other examples may differ from what is described with regard to FIG. 10.

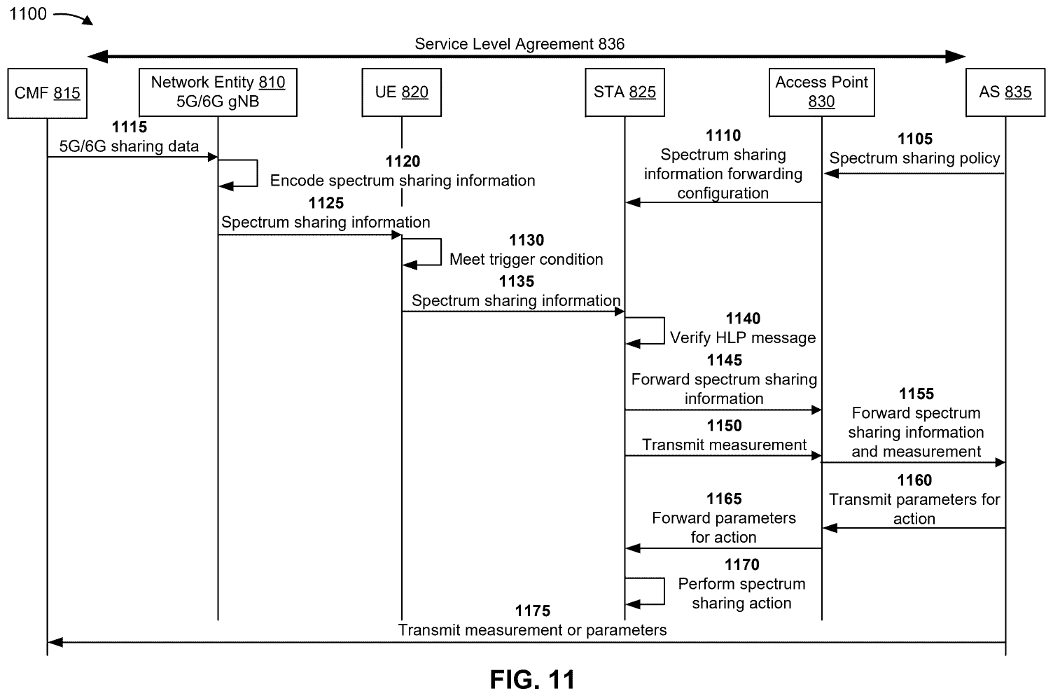

FIG. 11 is a diagram illustrating an example 1100 of cross-technology signaling, in accordance with the present disclosure.

As shown by reference number 1105, the AS 835 may transmit a spectrum sharing policy to the AP 830. As shown by reference number 1110, the AP 830 may transmit a configuration for forwarding spectrum sharing information to the AP 830. As shown by reference number 1115, the CMF 815 may transmit sharing data to the network entity 810.

Example 1100 shows cross-technology signaling from the UE 820 to the STA 825, where the AP 830 and/or the AS 835 decides the action the STA 825 is to perform in order to better share the spectrum. As shown by reference number 1120, the network entity 810 may encode spectrum sharing information based at least in part on the sharing data. As shown by reference number 1125, the network entity 810 may transmit the spectrum sharing information to the UE 820.

The UE 820 may detect that some event has met a trigger condition, as shown by reference number 1130. As shown by reference number 1135, the UE 820 may transmit the spectrum sharing information based at least in part on the trigger condition being met. The STA 825 may detect and receive the HLP message. As shown by reference number 1140, the STA 825 may verify the HLP message.

As shown by reference number 1145, the STA 825 may forward the spectrum sharing information to the AP 830. In some aspects, as shown by reference number 1150, the STA 825 may also transmit a measurement, such as a measurement of a reference signal. As shown by reference number 1155, the AP 830 may forward the spectrum sharing information to the AS 835. The AP 830 may also forward the measurement. The AS 835 may receive the spectrum sharing information and/or the measurement information. The AS 835 may determine an action and/or parameters for the action (or an action already configured at the STA 825) for sharing the spectrum. As shown by reference number 1160, the AS 835 may transmit parameters for the action (or the action itself). As shown by reference number 1165, the AP 830 may forward the parameters (or action) to the STA 825.

As shown by reference number 1170, the STA 825 may perform on action configured by the AP 830 to share the spectrum with cellular entities, such as network entity 810 and/or UE 820. The action may include limiting operation to a part of the spectrum, reducing transmit power, and/or time domain sharing. Cross-technology collisions are minimized and the spectrum is better utilized by both technologies. In some aspects, as shown by reference number 1175, the AS 835 may transmit the measurement and/or the parameters to the CMF 815 in association with the cooperative service level agreement 836. The CMF 815 may use the measurement and/or parameters to transmit any new sharing data to the cellular entities.

In some aspects, the cellular entities may provide cross-technology signaling without synchronizing with the non-cellular entities. However, without the use of LBT, the AP 830 may be expected to detect cross-technology signaling with a certain probability within a maximum specific time duration or gap. Once cross-technology signaling is detected, the AP 830 may enter a restricted channel use state and remain there until a condition to return to a free channel use state is met. The AP 830 may set a timer that determines when the AP 830 is in the restricted channel state. During the restricted channel state, the AP 830 may communicate (and configure STAs to communicate) in a more limited frequency range or time or with a smaller transmit power. The timer may stop when cross-technology signaling is received or channel monitoring has stopped. The cross-technology signaling may be received in-band (regular channels, resources, protocols) or out-of-band (on other channels, resources, or protocols).

As indicated above, FIG. 11 is provided as an example. Other examples may differ from what is described with regard to FIG. 11.

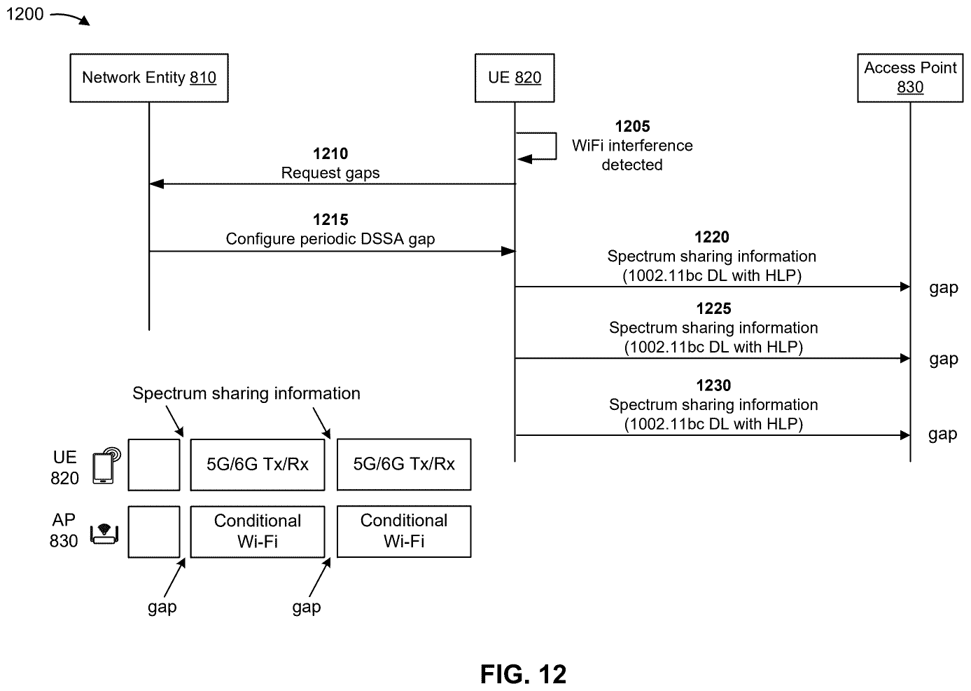

FIG. 12 is a diagram illustrating an example 1200 of transmitting spectrum sharing information in configured gaps, in accordance with the present disclosure.

In some aspects, the network entity 810 (e.g., configured by the CMF 815) may configure the UE 820 to transmit a cross-technology message, such as the spectrum sharing information, in one or more time instances. The one or more time instances may be in one or more configured gaps. The gaps may be periodic with a period as low as 20 milliseconds (ms). Gap lengths may be, for example, 3, 4, 6, 10, and 20 ms. Aperiodic gaps may be triggered. The gaps may be long enough for the UE to complete an LBT procedure. The gaps may include MUSIM gaps for MUSIM operation.

The AP 830 may be configured to monitor for cross-technology signaling in the gaps. In some aspects, the AP 830 may monitor on a channel that is specific to cross-technology signaling. The AP 830 may utilize the channel for other resources or use other resources outside of the gaps (if the AP 830 did not receive cross-technology signaling for time). Upon receiving cross-technology signaling, such as spectrum sharing information, the AP 830 may vacate the corresponding resources or follow an interference management procedure specified by the spectrum sharing information in an HLP 802.11bc UL frame. By using the configured gaps, the AP 830 may be prepared to receive spectrum sharing information cellular entities and perform actions for sharing the spectrum.

As shown by reference number 1205, the UE 820 may detect Wi-Fi interference. As shown by reference number 1210, the UE 820 may request gaps for the transmission of spectrum sharing information in the gaps. As shown by reference number 1215, the network entity 810 may configure the UE 820 with periodic DSSA gaps. The cellular entity may also provide spectrum sharing information. The UE 820 may provide the spectrum sharing information in the configured gaps, as shown by reference numbers 1220, 1225, and 1230. In example 1200, the AP 830 may receive the spectrum sharing information in gaps. In other example, the STA 825 may receive the spectrum sharing information in gaps.

The use of the gaps, parameters, and/or interference mitigation techniques may depend on the GNSS synchronization capabilities of the AP 830. The AP 830 may acquire GNSS synchronization autonomously through a GNSS receiver or through cross-technology signaling from the network entity 810 or UE 820. Cross-technology signaling in the gaps allows the AP 830 (GNSS synchronized) to sense the channel at specific time instances and utilize the channel in between the two instances without the risk of miss detection. Synchronization allows the AP 830 to be more aggressive with sharing resources with cellular entities, because there is a mechanism to more reliably detect cross-technology signaling. Synchronization also allows the use of smaller gaps.

In some aspects, the UE 820 may be configured to transmit the same waveform at the same time (creating an SFN effect) or utilize different waveforms. The network entity 810 may offset those transmissions to manage cross-interference between transmissions.

As indicated above, FIG. 12 is provided as an example. Other examples may differ from what is described with regard to FIG. 12.

FIG. 13 is a diagram illustrating an example process 1300 performed, for example, at a wireless station or an apparatus of a wireless STA, in accordance with the present disclosure. Example process 1300 is an example where the apparatus or the wireless STA (e.g., wireless communication device 500, mobile station, STA 825) performs operations associated with cross-technology spectrum sharing.

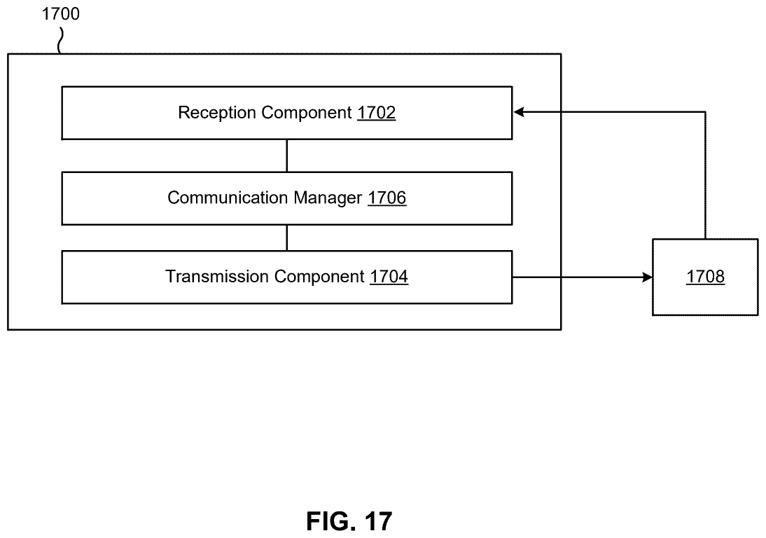

As shown in FIG. 13, in some aspects, process 1300 may include receiving spectrum sharing information from a network entity or a UE (block 1310). For example, the wireless STA (e.g., using reception component 1702 and/or communication manager 1706, depicted in FIG. 17) may receive spectrum sharing information from a network entity or a UE, as described above.

As further shown in FIG. 13, in some aspects, process 1300 may include performing an action associated with sharing a spectrum with cellular communications (block 1320). For example, the wireless STA (e.g., using communication manager 1706, depicted in FIG. 17) may perform an action associated with sharing a spectrum with cellular communications, as described above.

Process 1300 may include additional aspects, such as any single aspect or any combination of aspects described below and/or in connection with one or more other processes described elsewhere herein.

In a first aspect, receiving the spectrum sharing information includes receiving the spectrum sharing information in an HLP message with a WLAN protocol (e.g., Wi-Fi protocol), and verifying the HLP message.

In a second aspect, alone or in combination with the first aspect, process 1300 includes receiving a configuration for the action from a wireless AP.

In a third aspect, alone or in combination with one or more of the first and second aspects, the action includes one or more of limiting WLAN protocol communications to a portion of the spectrum or reducing power for WLAN communications of the wireless STA in the spectrum.

In a fourth aspect, alone or in combination with one or more of the first through third aspects, the action includes time domain sharing with cellular communications in the spectrum.

In a fifth aspect, alone or in combination with one or more of the first through fourth aspects, the spectrum sharing information is associated with a service level agreement between a CMF and an authorization server.

In a sixth aspect, alone or in combination with one or more of the first through fifth aspects, process 1300 includes forwarding the spectrum sharing information to a wireless AP, and receiving parameters for the action, where the parameters are associated with the spectrum sharing information.

In a seventh aspect, alone or in combination with one or more of the first through sixth aspects, process 1300 includes receiving a configuration for the forwarding of the spectrum sharing information.

In an eighth aspect, alone or in combination with one or more of the first through seventh aspects, process 1300 includes transmitting a measurement to the wireless AP.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network entity or UE or an apparatus of a network entity or UE, in accordance with the present disclosure. Example process 1400 is an example where the apparatus or the network entity or UE (e.g., UE 120, network node 110, network entity 810, UE 820) performs operations associated with cross-technology spectrum sharing.

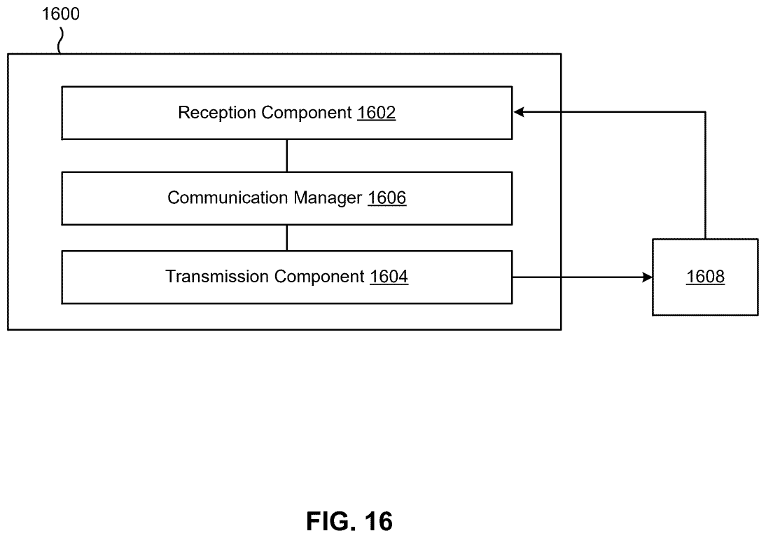

As shown in FIG. 14, in some aspects, process 1400 may include receiving sharing data that is associated with a service level agreement between a cellular CMF and a WLAN protocol authorization server for sharing a spectrum between cellular communications and WLAN protocol communications (block 1410). For example, the network entity or UE (e.g., using reception component 1602 and/or communication manager 1606, depicted in FIG. 16) may receive sharing data that is associated with a service level agreement between a CMF and an authorization server for sharing a spectrum between cellular communications and WLAN protocol communications, as described above.

As further shown in FIG. 14, in some aspects, process 1400 may include transmitting, to a wireless station, spectrum sharing information that is based at least in part on the sharing data (block 1420). For example, the cellular entity (e.g., using transmission component 1604 and/or communication manager 1606, depicted in FIG. 16) may transmit, to a wireless station, spectrum sharing information that is based at least in part on the sharing data, as described above.

Process 1400 may include additional aspects, such as any single aspect or any combination of aspects described below and/or in connection with one or more other processes described elsewhere herein.

In a first aspect, the network entity or UE is a network entity.

In a second aspect, alone or in combination with the first aspect, the network entity or UE is a UE.

In a third aspect, alone or in combination with one or more of the first and second aspects, process 1400 includes transmitting, based at least in part on a detection of WLAN protocol interference, a request for gaps for transmission of spectrum sharing information, and receiving a configuration for the gaps, where transmitting the spectrum sharing information includes transmitting the spectrum sharing information in a configured gap.

In a fourth aspect, alone or in combination with one or more of the first through third aspects, transmitting the spectrum sharing information includes transmitting the spectrum sharing information in a HLP message.

In a fifth aspect, alone or in combination with one or more of the first through fourth aspects, transmitting the spectrum sharing information includes broadcasting the spectrum sharing information based at least in part on a triggering condition.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, at a wireless AP or an apparatus of a wireless AP, in accordance with the present disclosure. Example process 1500 is an example where the apparatus or the wireless AP (e.g., wireless communication device, AP 830) performs operations associated with cross-technology spectrum sharing.

As shown in FIG. 15, in some aspects, process 1500 may include receiving, from an authorization server, a spectrum sharing policy that is associated with a service level agreement between the authorization server and a CMF (block 1510). For example, the wireless AP (e.g., using reception component 1702 and/or communication manager 1706, depicted in FIG. 17) may receive, from a authorization server, a spectrum sharing policy that is associated with a service level agreement between the authorization server and a CMF, as described above.

As further shown in FIG. 15, in some aspects, process 1500 may include transmitting, to a wireless STA, parameters for an action to be performed by the wireless STA in association with sharing a spectrum with cellular communications (block 1520). For example, the wireless AP (e.g., using transmission component 1704 and/or communication manager 1706, depicted in FIG. 17) may transmit, to a wireless STA, parameters for an action to be performed by the wireless STA in association with sharing a spectrum with cellular communications, as described above.

Process 1500 may include additional aspects, such as any single aspect or any combination of aspects described below and/or in connection with one or more other processes described elsewhere herein.

In a first aspect, process 1500 includes transmitting a configuration for the action or for the wireless STA to forward spectrum sharing information to the wirelss AP.

In a second aspect, alone or in combination with the first aspect, process 1500 includes receiving a measurement from the wireless STA, forwarding the measurement to the authorization server, receiving parameters or a configuration for the action, and forwarding the parameters or the configuration to the wireless STA.

In a third aspect, alone or in combination with one or more of the first and second aspects, the service level agreement is associated with exchanging measurements or parameters between the authorization server and the CMF.

In a fourth aspect, alone or in combination with one or more of the first through third aspects, process 1500 includes entering a restricted channel state for a first time duration based at least in part on receiving a cross-technology message.

In a fifth aspect, alone or in combination with one or more of the first through fourth aspects, receiving the cross-technology message includes receiving the cross-technology message at a configured gap.

In a sixth aspect, alone or in combination with one or more of the first through fifth aspects, process 1500 includes obtaining synchronization with a network entity or a UE in association with one or more gaps.

In a seventh aspect, alone or in combination with one or more of the first through sixth aspects, receiving the cross-technology message includes receiving the cross-technology message on a channel associated with cross-technology signaling.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a network entity or UE (e.g., UE 120, network node 110), or a network entity or UE may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 140 or 150 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 1-12. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the cellular entity described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, one or more modems, one or more demodulators, one or more MIMO detectors, one or more receive processors, one or more controllers/processors, one or more memories, or a combination thereof, of the cellular entity described in connection with FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, one or more modems, one or more modulators, one or more transmit MIMO processors, one or more transmit processors, one or more controllers/processors, one or more memories, or a combination thereof, of the cellular entity described in connection with FIG. 2. In some aspects, the transmission component 1604 may be co-located with the reception component 1602 in one or more transceivers.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The reception component 1602 may receive sharing data that is associated with a service level agreement between a cellular CMF and a WLAN protocol authorization server for sharing a spectrum between cellular communications and WLAN protocol communications. The transmission component 1604 may transmit, to a wireless STA, spectrum sharing information that is based at least in part on the sharing data.

The transmission component 1604 may transmit, based at least in part on a detection of WLAN protocol interference, a request for gaps for transmission of spectrum sharing information.

The reception component 1602 may receive a configuration for the gaps and the transmission component 1604 may transmit the spectrum sharing information in a configured gap.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a WLAN protocol entity (e.g., Wi-Fi entity, wireless communication device 150, wireless STA, wireless AP), or a WLAN protocol entity may include the apparatus 1700. In some aspects, the apparatus 1700 includes a reception component 1702, a transmission component 1704, and/or a communication manager 1706, which may be in communication with one another (for example, via one or more buses and/or one or more other components). In some aspects, the communication manager 1706 is the communication manager 570 described in connection with FIG. 5. As shown, the apparatus 1700 may communicate with another apparatus 1708, such as a UE or a network node (such as a CU, a DU, an RU, or a base station), using the reception component 1702 and the transmission component 1704.

In some aspects, the apparatus 1700 may be configured to perform one or more operations described herein in connection with FIGS. 1-12. Additionally, or alternatively, the apparatus 1700 may be configured to perform one or more processes described herein, such as process 1300 of FIG. 13, process 1500 of FIG. 15, or a combination thereof. In some aspects, the apparatus 1700 and/or one or more components shown in FIG. 17 may include one or more components of the access point described in connection with FIG. 5. Additionally, or alternatively, one or more components shown in FIG. 17 may be implemented within one or more components described in connection with FIG. 5. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, one or more modems, one or more controllers/processors, one or more memories, or a combination thereof, of the access point described in connection with FIG. 5.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1708. In some aspects, the transmission component 1704 may include one or more antennas, one or more modems, one or more modulators, one or more transmit MIMO processors, one or more transmit processors, one or more controllers/processors, one or more memories, or a combination thereof, of the access point described in connection with FIG. 2. In some aspects, the transmission component 1704 may be co-located with the reception component 1702 in one or more transceivers.

The communication manager 1706 may support operations of the reception component 1702 and/or the transmission component 1704. For example, the communication manager 1706 may receive information associated with configuring reception of communications by the reception component 1702 and/or transmission of communications by the transmission component 1704. Additionally, or alternatively, the communication manager 1706 may generate and/or provide control information to the reception component 1702 and/or the transmission component 1704 to control reception and/or transmission of communications.

In some aspects associated with a wireless station, the reception component 1702 may receive spectrum sharing information from a cellular entity. The communication manager 1706 may perform an action associated with sharing a spectrum with cellular communications.

The communication manager 1706 may forward the spectrum sharing information to wireless AP. The reception component 1702 may receive parameters for the action, where the parameters are associated with the spectrum sharing information. The transmission component 1704 may transmit a measurement to the wireless AP.

The reception component 1702 may receive a configuration for the action from a wireless AP. The reception component 1702 may receive a configuration for the forwarding of the spectrum sharing information.

In some aspects associated with an AP, the reception component 1702 may receive, from an authorization server, a spectrum sharing policy that is associated with a service level agreement between the authorization server and a CMF. The transmission component 1704 may transmit, to a wireless STA, parameters for an action to be performed by the wireless STA in association with sharing a spectrum with cellular communications.

The transmission component 1704 may transmit a configuration for the action or for the wireless STA to forward spectrum sharing information to the wireless AP.

The reception component 1702 may receive a measurement from the wireless STA. The communication manager 1706 may forward the measurement to the authorization server. The reception component 1702 may receive parameters or a configuration for the action. The communication manager 1706 may forward the parameters or the configuration to the wireless station.

The communication manager 1706 may enter a restricted channel state for a first time duration based at least in part on receiving a cross-technology message. The reception component 1702 may obtain synchronization with a cellular entity in association with one or more gaps.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a wireless station, comprising: receiving spectrum sharing information from a network entity or a user equipment (UE); and performing an action associated with sharing a spectrum with cellular communications.

Aspect 2: The method of Aspect 1, wherein receiving the spectrum sharing information includes: receiving the spectrum sharing information in a higher layer payload (HLP) message with a wireless local area network (WLAN) protocol; and verifying the HLP message.

Aspect 3: The method of any of Aspects 1-2, further comprising receiving a configuration for the action from a wireless access point.

Aspect 4: The method of any of Aspects 1-3, wherein the action includes one or more of limiting WLAN communications to a portion of the spectrum or reducing power for WLAN communications of the wireless station in the spectrum.

Aspect 5: The method of any of Aspects 1-4, wherein the action includes time domain sharing with cellular communications in the spectrum.

Aspect 6: The method of any of Aspects 1-5, wherein the spectrum sharing information is associated with a service level agreement between a channel management function and an authorization server.

Aspect 7: The method of any of Aspects 1-6, further comprising: forwarding the spectrum sharing information to a wireless access point; and receiving parameters for the action, wherein the parameters are associated with the spectrum sharing information.

Aspect 8: The method of Aspect 7, further comprising receiving a configuration for the forwarding of the spectrum sharing information.

Aspect 9: The method of Aspect 7, further comprising transmitting a measurement to the wireless access point.

Aspect 10: A method of wireless communication performed by a user equipment (UE), comprising: receiving sharing data that is associated with a service level agreement between a channel measurement function (CMF) and an authorization server for sharing a spectrum between cellular communications and wireless local area network (WLAN) protocol communications; and transmitting, to a wireless station, spectrum sharing information that is based at least in part on the sharing data.

Aspect 11: The method of Aspect 10, further comprising: transmitting, based at least in part on a detection of WLAN protocol interference, a request for gaps for transmission of spectrum sharing information; and receiving a configuration for the gaps, wherein transmitting the spectrum sharing information includes transmitting the spectrum sharing information in a configured gap.

Aspect 12: The method of Aspect 10 or 11, wherein transmitting the spectrum sharing information includes transmitting the spectrum sharing information in a higher layer payload (HLP) message.

Aspect 13: The method of any of Aspects 10-12, wherein transmitting the spectrum sharing information includes broadcasting the spectrum sharing information based at least in part on a triggering condition.

Aspect 14: A method of wireless communication performed by a network entity, comprising: receiving sharing data that is associated with a service level agreement between a channel measurement function (CMF) and an authorization server for sharing a spectrum between cellular communications and wireless local area network (WLAN) protocol communications; and transmitting, to a wireless station, spectrum sharing information that is based at least in part on the sharing data.

Aspect 15: The method of Aspect 14, wherein transmitting the spectrum sharing information includes transmitting the spectrum sharing information in a higher layer payload (HLP) message.

Aspect 16: The method of Aspect 14 or 15, wherein transmitting the spectrum sharing information includes broadcasting the spectrum sharing information based at least in part on a triggering condition.

Aspect 17: A method of wireless communication performed by a wireless access point, comprising: receiving, from an authorization server, a spectrum sharing policy that is associated with a service level agreement between the authorization server and a channel measurement function (CMF); and transmitting, to a wireless station, parameters for an action to be performed by the wireless station in association with sharing a spectrum with cellular communications.

Aspect 18: The method of Aspect 17, further comprising transmitting a configuration for the action or for the wireless station to forward spectrum sharing information to the wireless access point.

Aspect 19: The method of Aspect 17 or 18, further comprising: receiving a measurement from the wireless station; forwarding the measurement to the authorization server; receiving parameters or a configuration for the action; and forwarding the parameters or the configuration to the wireless station.

Aspect 20: The method of any of Aspects 17-19, wherein the service level agreement is associated with exchanging wireless local area network (WLAN) protocol measurements or parameters between the authorization server and the CMF.

Aspect 21: The method of any of Aspects 17-20, further comprising entering a restricted channel state for a first time duration based at least in part on receiving a cross-technology message.

Aspect 22: The method of Aspect 21, wherein receiving the cross-technology message includes receiving the cross-technology message at a configured gap.

Aspect 23: The method of Aspect 21, further comprising obtaining synchronization with a network entity or a user equipment (UE) in association with one or more gaps.

Aspect 24: The method of Aspect 21, wherein receiving the cross-technology message includes receiving the cross-technology message on a channel associated with cross-technology signaling.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.

Aspect 26: An apparatus for wireless communication at a device, the apparatus comprising one or more memories and one or more processors coupled to the one or more memories, the one or more processors configured to cause the device to perform the method of one or more of Aspects 1-24.

Aspect 27: An apparatus for wireless communication, the apparatus comprising at least one means for performing the method of one or more of Aspects 1-24.

Aspect 28: A non-transitory computer-readable medium storing code for wireless communication, the code comprising instructions executable by one or more processors to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

Aspect 30: A device for wireless communication, the device comprising a processing system that includes one or more processors and one or more memories coupled with the one or more processors, the processing system configured to cause the device to perform the method of one or more of Aspects 1-24.

Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an clement “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a wireless station, comprising:
one or more memories; and
one or more processors, coupled to the one or more memories, individually or collectively configured to cause the wireless station to:
receive spectrum sharing information from a network entity or a user equipment (UE); and
perform an action associated with sharing a spectrum with cellular communications.

2. The apparatus of claim 1, wherein to receive the spectrum sharing information, the one or more processors are individually or collectively configured to cause the wireless station to:
receive the spectrum sharing information in a higher layer payload (HLP) message with a wireless local area network (WLAN) protocol; and
verify the HLP message.

3. The apparatus of claim 1, wherein the one or more processors are individually or collectively configured to cause the wireless station to receive a configuration for the action from a wireless access point.

4. The apparatus of claim 1, wherein the one or more processors are individually or collectively configured to cause the wireless station to limit wireless local area network (WLAN) protocol communications to a portion of the spectrum or reducing power for WLAN protocol communications of the wireless station in the spectrum.

5. The apparatus of claim 1, wherein the action includes time domain sharing with cellular communications in the spectrum.

6. The apparatus of claim 1, wherein the spectrum sharing information is associated with a service level agreement between a channel management function and an authorization server.

7. The apparatus of claim 1, wherein the one or more processors are individually or collectively configured to cause the wireless station to:
forward the spectrum sharing information to a wireless access point; and
receive parameters for the action, wherein the parameters are associated with the spectrum sharing information.

8. The apparatus of claim 7, wherein the one or more processors are individually or collectively configured to cause the wireless station to receive a configuration for the forwarding of the spectrum sharing information.

9. The apparatus of claim 7, wherein the one or more processors are individually or collectively configured to cause the wireless station to transmit a measurement to the wireless access point.

10. An apparatus for wireless communication at a user equipment (UE), comprising:
one or more memories; and
one or more processors, coupled to the one or more memories, individually or collectively configured to cause the UE to:
receive sharing data that is associated with a service level agreement between a channel measurement function (CMF) and an authorization server for sharing a spectrum between cellular communications and wireless local area network (WLAN) protocol communications; and
transmit, to a wireless station, spectrum sharing information that is based at least in part on the sharing data.

11. The apparatus of claim 10, wherein the one or more processors are individually or collectively configured to cause the UE to:
transmit, based at least in part on a detection of WLAN protocol interference, a request for gaps for transmission of spectrum sharing information; and
receive a configuration for the gaps,
wherein to transmit the spectrum sharing information, the one or more processors are individually or collectively configured to cause the UE to transmit the spectrum sharing information in a configured gap.

12. The apparatus of claim 10, wherein to transmit the spectrum sharing information, the one or more processors are individually or collectively configured to cause the UE to transmit the spectrum sharing information in a higher layer payload (HLP) message.

13. The apparatus of claim 12, wherein to transmit the spectrum sharing information, the one or more processors are individually or collectively configured to cause the UE to broadcast the spectrum sharing information based at least in part on a triggering condition.

14. An apparatus for wireless communication at a network entity, comprising:
one or more memories; and
one or more processors, coupled to the one or more memories, individually or collectively configured to cause the network entity to:
receive sharing data that is associated with a service level agreement between a channel measurement function (CMF) and an authorization server for sharing a spectrum between cellular communications and wireless local area network (WLAN) protocol communications; and
transmit, to a wireless station, spectrum sharing information that is based at least in part on the sharing data.

15. The apparatus of claim 14, wherein to transmit the spectrum sharing information, the one or more processors are individually or collectively configured to cause the network entity to transmit the spectrum sharing information in a higher layer payload (HLP) message.

16. The apparatus of claim 14, wherein to transmit the spectrum sharing information, the one or more processors are individually or collectively configured to cause the network entity to broadcast the spectrum sharing information based at least in part on a triggering condition.

17. An apparatus for wireless communication at a wireless access point, comprising:
one or more memories; and
one or more processors, coupled to the one or more memories, individually or collectively configured to cause the wireless access point to:
receive, from an authorization server, a spectrum sharing policy that is associated with a service level agreement between the authorization server and a channel measurement function (CMF); and
transmit, to a wireless station, parameters for an action to be performed by the wireless station in association with sharing a spectrum with cellular communications.

18. The apparatus of claim 17, wherein the one or more processors are individually or collectively configured to cause the wireless access point to transmit a configuration for the action or for the wireless station to forward spectrum sharing information to the wireless access point.

19. The apparatus of claim 17, wherein the one or more processors are individually or collectively configured to cause the wireless access point to:
receive a measurement from the wireless station;
forward the measurement to the authorization server;
receive parameters or a configuration for the action; and
forward the parameters or the configuration to the wireless station.

20. The apparatus of claim 17, wherein the one or more processors are individually or collectively configured to cause the wireless access point to enter a restricted channel state for a first time duration based at least in part on receiving a cross-technology message.

21. The apparatus of claim 20, wherein to receive the cross-technology message, the one or more processors are individually or collectively configured to cause the wireless access point to receive the cross-technology message at a configured gap.

22. The apparatus of claim 20, wherein to receive the cross-technology message, the one or more processors are individually or collectively configured to cause the wireless access point to receive the cross-technology message on a channel associated with cross-technology signaling.
